(19) United States
(12) Patent Application Publication
(10) Pub. No.: US 2018/0069897 A1
(43) Pub. Date: Mar. 8, 2018

(54) VISUALIZATION OF SECURITY ENTITLEMENT RELATIONSHIPS TO IDENTIFY SECURITY PATTERNS AND RISKS

(71) Applicant: CA, Inc., NEW YORK, NY (US)

(72) Inventor: CHRISTOPHER ROLLIN MORRIS, KATY, TX (US)

(21) Appl. No.: 15/257,061

(22) Filed: Sep. 6, 2016

(51) Int. Cl. H04L 29/06; G06T 11/20

(52) U.S. Cl. CPC H04L 63/20; H04L 63/10; G06F 2221/2101; G06T 11/203; G06T 11/206

(57) ABSTRACT

A visualization depicting visual relationships between identities and entitlements is provided by a visualization device to enable patterns corresponding to the relationships to be readily identifiable. Initially, data comprising identities and entitlements is received and utilized to create the visualization. The visualization is optimized to depict potential risks associated with selected identities and corresponding entitlements. An interaction directed to a particular identity or a particular entitlement that is depicted as a potential risk by the visualization is received that causes a rule to be created for the particular identity or the particular entitlement. The risk may be manually or automatically directed to a security department or automated provisions system where the risk associated with the particular identity or the particular entitlement is mitigated by modifying rights of the particular identity for the particular entitlement.

### BACKGROUND

Organizations often struggle to understand which users (e.g., employees) have access to which entitlements (e.g., security clearance assigned to an identity that provides access to a particular group, resource, or some type of security key) in an online enterprise setting. Even more challenging to the organizations is understanding access or utilization relationships between groups of users or groups of entitlements. Today, role mining is accomplished by studying the results of heavy analytic tools that provide spreadsheets of data as output. Although these tools may contain some information regarding access or utilization relationships, it is hidden within thousands or millions of rows of data in the spreadsheet. Identifying and isolating the information requires manipulating the thousands or millions of rows of data and it is cost-prohibitive (i.e., time, manpower) to actually determine patterns in usage across the enterprise, which prevents these patterns from being utilized to benefit the organization. Further, no visualization is provided that enables a user to readily identify patterns or meaningful artifacts (i.e., new information) in the data that can be valuable to the organization.

### SUMMARY

This summary is provided to introduce a selection of concepts in a simplified form that are further described below in the detailed description. This summary is not intended to identify key features or essential features of the claimed subject matter, nor should it be used as an aid in determining the scope of the claimed subject matter.

Embodiments of the present disclosure relate to visualizations depicting visual relationships between identities and entitlements that enable patterns corresponding to the relationships to be readily identifiable. To do so, data comprising identities (e.g., HR data) and entitlements (e.g., application data from applications) is received and utilized to create a visualization. The visualization is optimized to depict security patterns and potential risks associated with selected identities and corresponding entitlements. An interaction directed to a particular identity or a particular entitlement that is depicted as a potential risk by the visualization is received. The risk may be manually or automatically directed to a security department or automated provisions system where the risk associated with the particular identity or the particular entitlement is mitigated by modifying rights of the particular identity for the particular entitlement.

### BRIEF DESCRIPTION OF THE DRAWINGS

The present invention is described in detail below with reference to the attached drawing figures, wherein:

FIG. 1 is a block diagram showing a visualization system that provides a visualization of security entitlement relationships to identify security patterns and mitigate risks, in accordance with an embodiment of the present disclosure;

FIG. 2 is a block diagram showing an exemplary flow of information between a visualization system and an organization, in accordance with an embodiment of the present disclosure;

FIGS. 3-9 are exemplary diagrams illustrating visualizations of security entitlement relationships to identify security patterns and mitigate risks, in accordance with embodiments of the present disclosure;

FIGS. 10-11 are flow diagrams showing methods for providing visualizations of security entitlement relationships to identify security patterns and mitigate risks, in accordance with embodiments of the present disclosure; and

FIG. 12 is a block diagram of an exemplary computing environment suitable for use in implementing embodiments of the present disclosure.

### DETAILED DESCRIPTION

The subject matter of the present disclosure is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described. As used herein, the singular forms “a,” “an,” and “the” are intended to include the plural forms as well, unless the context clearly indicates otherwise.

As noted in the background, organizations often struggle to understand which users (e.g., employees) have access to which entitlements (e.g., security clearances) in an online enterprise setting. Even more challenging to the organizations is understanding access or utilization relationships between groups of users or groups of entitlements. Today, role mining is accomplished by studying the results of heavy analytic tools that provide spreadsheets of data as output. Although these tools may contain some information regarding access or utilization relationships, it is hidden within thousands or millions of rows of data in the spreadsheet. Identifying and isolating the information requires manipulating the thousands or millions of rows of data and it is cost-prohibitive (i.e., time, manpower) to actually determine patterns in usage across the enterprise, which prevents these patterns from being utilized to benefit the organization. Further, no visualization is provided that enables a user to readily identify patterns or meaningful artifacts (i.e., new information) in the data that can be valuable to the organization.

Embodiments of the present disclosure are generally directed to providing visualizations that depict visual relationships between identities (e.g., user accounts corresponding to employees) and entitlements (e.g., security clearance assigned to an identity that provides access to a particular group, resource, or some type of security key). The visualizations enable patterns corresponding to the relationships to be readily identifiable and can receive interactions that allow risks to be easily mitigated. Initially, data comprising identities (e.g., HR data) and entitlements (e.g., entitlement data from applications) is received and utilized to create a visualization. The visualization can be optimized to depict security patterns and potential risks associated with selected identities and corresponding entitlements. For example, the visualization can be optimized to show terminated identities having access to entitlements. In another example, the visualization can be optimized to show relationships between identities and entitlements for a particular group within the organization.

When an interaction directed to a particular identity or a particular entitlement that is depicted as a potential risk by the visualization is received, a rule can be created for the particular identity or the particular entitlement. The risk may be manually or automatically directed to a security department or automated provisioning device where the risk associated with the particular identity or the particular entitlement is mitigated by modifying rights of the particular identity for the particular entitlement. When the rule is communicated to an automated provisioning system and executed, the automated provisioning system mitigates risk associated with the particular identity or the particular entitlement by modifying rights of the particular identity for the particular entitlement.

Accordingly, one embodiment of the present disclosure is directed to a computer-implemented method to facilitate providing visualizations of security entitlement relationships to identify security patterns and mitigate risks. The method comprises receiving, at a visualization device, a set of data. The set of data comprises identities and corresponding entitlements. The method also comprises providing, by the visualization device, a visualization (i.e., a node-edge graph) that depicts visual relationships between the identities and corresponding entitlements. The method further comprises optimizing the visualization to depict potential risks associated with selected identities and corresponding entitlements. The potential risks comprise a portion of the identities having a high quantity of corresponding entitlements compared to other identities in the organization, terminated identities having a corresponding entitlement, or null identities that are unknown to an organization device and having a corresponding entitlement. The method also comprises receiving an interaction directed to a particular identity or a particular entitlement that is depicted as a potential risk by the visualization. The interaction causes the visualization device to create a rule for the particular identity or the particular entitlement. The method further comprises communicating the rule to an automated provisioning system that, when executed by the automated provisioning system, causes the organization device to mitigate risk associated with the particular identity or particular entitlement by modifying rights of the particular identity for the particular entitlement.

In another embodiment, the present disclosure is directed to a non-transitory computer storage medium storing computer-useable instructions that, when used by a computing device, causes the computing device to perform operations to facilitate providing visualizations of security entitlement relationships to identify security patterns and mitigate risks. The operations include providing a set of data comprising identities or corresponding entitlements to a visualization device. The operations also include, based on an interaction received from a user at a visualization provided by the visualization device, receiving a rule created by the visualization device. The visualization indicates potential risks corresponding to the set of data. The operations further include based on an action corresponding to the rule by an automated provisioning system, mitigating a risk associated with a particular identity or a particular entitlement.

In yet another embodiment, the present disclosure is directed to a system for providing visualizations of security entitlement relationships to identify security patterns and mitigate risks. The system includes a processor and a non-transitory computer storage medium storing computer-useable instructions that, when used by the processor, cause the processor to receive, at a visualization device, a set of data. The set of data comprises identities and corresponding entitlements. A visualization is provided, by the visualization device, that depicts visual relationships between the identities and corresponding entitlements. The visualization is a node-edge graph. The visualization is optimized to depict potential risks associated with selected identities and corresponding entitlements. An interaction directed to a particular identity or a particular entitlement that is depicted as a potential risk by the visualization is received and causes the visualization device to create a rule for the particular identity or the particular entitlement. The rule is communicated to an automated provisioning system that, when executed by the automated provisioning system, causes the automated provisioning system to perform an action that mitigates risk associated with the particular identity or the particular entitlement.

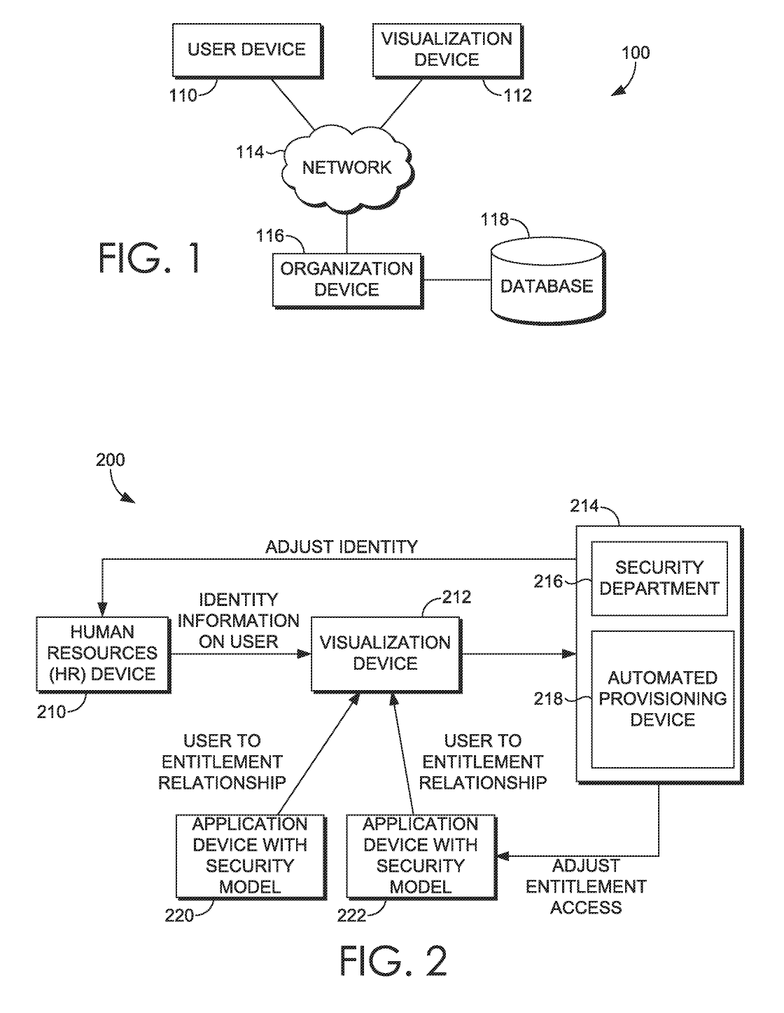

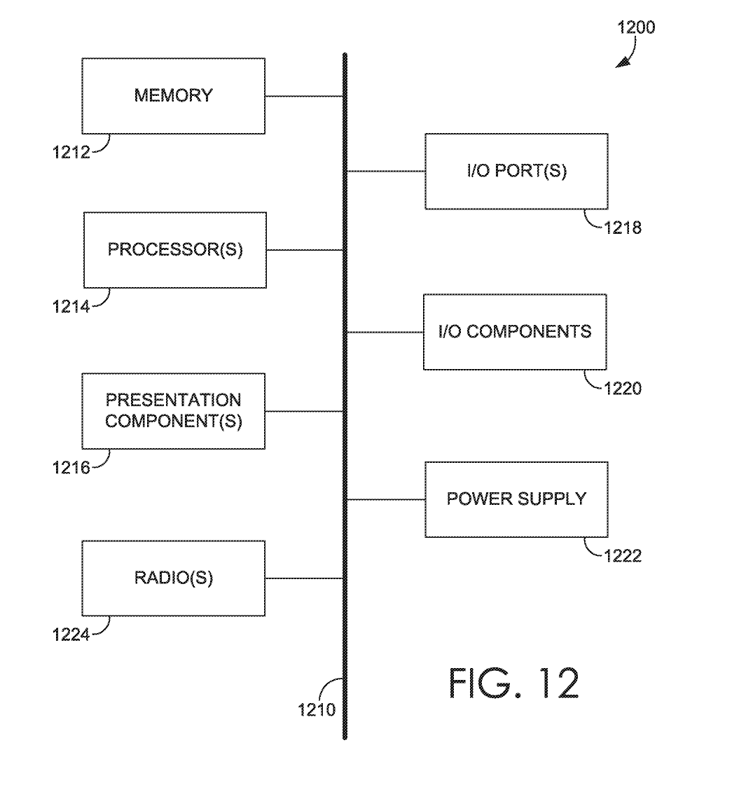

Referring now to FIG. 1, a block diagram is provided that illustrates a visualization system 100 for providing visualizations of security entitlement relationships to identify security patterns and mitigate risks, in accordance with an embodiment of the present disclosure. It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, various functions may be carried out by a processor executing instructions stored in memory. The visualization system 100 may be implemented via any type of computing device, such as computing device 1200 described below with reference to FIG. 12, for example. In various embodiments, the visualization system 100 may be implemented via a single device or multiple devices cooperating in a distributed environment.

The visualization system 100 generally operates to provide a user with visualizations of security entitlement relationships that help the user readily identify security patterns and mitigate risks. As shown in FIG. 1, the visualization system 100 includes, among other components not shown, user device 110, visualization device 112, organization device 116, and database 118. It should be understood that the visualization system 100 shown in FIG. 1 is an example of one suitable computing system architecture. Each of the components shown in FIG. 1 may be implemented via any type of computing device, such as computing device 1200 described with reference to FIG. 12, for example.

The components may communicate with each other via a network 114, which may include, without limitation, one or more local area networks (LANs) and/or wide area networks (WANs). Such networking environments are commonplace in offices, enterprise-wide computer networks, intranets, and the Internet. It should be understood that any number of user devices, visualization devices, organization devices, or databases may be employed within the visualization system 100 within the scope of the present disclosure. Each may comprise a single device or multiple devices cooperating in a distributed environment. For instance, the visualization device 112 or organization device 116 may be provided via multiple devices arranged in a distributed environment that collectively provide the functionality described herein. For example, the organization device 116 may include a human resources (HR) device, application devices, security system, and the like (such as those shown in FIG. 2 and as described below). In some embodiments, some or all functionality provided by visualization device 112 may be provided by user device 110. Additionally, other components not shown may also be included within the network environment.

As shown in FIG. 1, the visualization system 100 includes a database 118. While only a single database 118 is shown in FIG. 1, it should be understood that the visualization system 100 may employ any number of databases. Each organization device 116 may utilize multiple databases corresponding to different entities, affiliates, business units, systems, etc., of the organization. Each database 118 may store information corresponding to identities and entitlements designated by the organization. As described herein, based on interactions to a visualization, a rule may be created by the visualization device that alters information stored within the database 118.

The visualization system 100 initially receives a request from a user via user device 110 for a visualization of data. The visualization depicts relationships between identities and entitlements and enables the user to mitigate risks, as explained in more detail below, identified in the visualization. In response, a set of data from the organization device 116 (e.g., data stored in database 118) is received by visualization device 112. The set of data comprises identities and corresponding entitlements. For clarity, identities refer to user accounts corresponding to users (e.g., employees) within the organization. Entitlements refer to a security clearance assigned to an identity that provides access to a particular group (e.g., ACTIVE DIRECTORY group), resource (e.g., application, database, file, etc.), or to some type of security key (i.e., enabling the user to launch an application or log in to the operating system). For example, by becoming a member of a group, an identity corresponding to a user may have some additional type of access that allows the user to perform actions within the organization's computing environment (e.g., log in to server, launch application, access database, or perform actions within the server, application, or database).

After receiving the set of data from the organization device 116, the visualization device 112 provides a visualization that depicts visual relationships between the identities and corresponding entitlements. In embodiments, the visualization is a node-edge graph where each node represents an identity or entitlement and each line represents a relationship between the corresponding nodes. The visualizations enable patterns corresponding to the relationships to be readily identifiable and, in some embodiments, can receive interactions that allow risks to be easily mitigated.

In some embodiments, the visualization can be optimized by the user via the user device 110 to depict potential risks associated with selected identities and corresponding entitlements. For example, the visualization can be optimized to show terminated identities having access to entitlements. In another example, the visualization can be optimized to show relationships between identities and entitlements for a selected group within the organization.

The visualization may enable a user to initiate actions via the visualization that can be communicated back to other devices or systems for execution. When an interaction directed to a particular identity or a particular entitlement that is depicted as a potential risk by the visualization is received, such as from the user via the user device 110, a rule may be created for the particular identity or the particular entitlement. The rule can be communicated to the organization device 116 and, when executed, causes the organization device 116 to perform an action that mitigates risk associated with the particular identity or the particular entitlement. For example, the rule may communicate with a system, application, resource, etc., identified by the rule to modify rights of the particular identity for the particular entitlement. The organization device 116, as described in more detail below, may request the system, application, resource, etc., to modify the rights of the particular identity for the particular entitlement, or in some cases, the organization device 116 may have the ability to modify the rights of the particular identity for the particular entitlement directly.

In one example, the rule may be communicated to a particular server (e.g., the organization's ACTIVE DIRECTORY server that causes a particular identity to be removed from an ACTIVE DIRECTORY group). In another example, the rule may be communicated to a particular application causing the user account corresponding to the identity to have its access terminated within or be removed from the application.

The visualization may enable an organization to derive new artifacts as well as from the visualization. Moreover, a user may further interact with the visualization, such as by hovering over a particular identity or entitlement, to reveal additional information managed by another system. For example, the user may hover over an identity to reveal entitlements associated with that user across the organization. In a similar fashion, the user may hover over an entitlement to reveal identities associated with that entitlement across the organization. Other examples of artifacts may include hardware/software solutions that are no longer utilized and should be reclaimed/recycled to provide a cost savings benefit, users that are “over-entitled”, rogue accounts (i.e., accounts created outside of a normal process to breach security). The visualization may provide real-time or historical data, depending on selections made by the user.

In some embodiments, the user can interact with the visualization to select an object (such as by selecting a particular identity) and create a rule based on the interaction that that provides the same entitlements to a new object (i.e., identity) as the selected object. In some embodiments, a user can interact with the visualization to remove an edge from the visualization. In response, a rule may be created that removes the relationship corresponding to the edge between the affected identity and entitlement (or removes the entitlement or identity entirely).

In some embodiments, the visualization is color-coded (or otherwise provides visually distinguishing characteristics) to distinguish between different groups of people (e.g., business units or roles within the organization), risk levels, etc. This enables a user to readily identify common entitlements for similar identities or potential risks to the organization.

Importantly, the visualization device 112, by way of the visualization, enables two-way communication between the user device 110 and the organization device 116 and/or affected systems, applications, resources, etc. In this way, the visualization provides a one-stop shop for managing identities and entitlements and removes significant delays caused by artificial intelligence processing, the use of heavy algorithms, and user analysis of spreadsheets.

Although the visualization system 100 of FIG. 1 has been simplified to depict interaction with an organization device 116, an exemplary visualization system 200 is depicted in FIG. 2 that illustrates one example of information flow between a visualization device 212 and an organization. As illustrated, the visualization device 212 receives information from various application devices 220, 222 as well as Human Resources (HR) device 210. The information may include identity information about the user (i.e., from HR device) as well as user to entitlement relationship information (i.e., from application devices). This information is utilized by visualization device 212 to provide visualizations that depict visual relationships between identities (e.g., user accounts corresponding to employees) and entitlements (e.g., security clearance assigned to an identity that provides access to a particular group, resource, or some type of security key). Interactions with the visualizations may enable communication with the security system 214. In one example, the user may choose to communicate the rule to security department 216. The rule alerts personnel in the security department 216 to manually adjust relationships between identities and entitlements for applications provided by application devices 220, 222. In another example, interactions with the visualizations may create rules that are communicated to automated provisioning device 218. These rules may automatically adjust relationships between identities and entitlements for applications provided by application devices 220, 222. Information corresponding to the adjusted relationships may then be communicated back to the HR device 210.

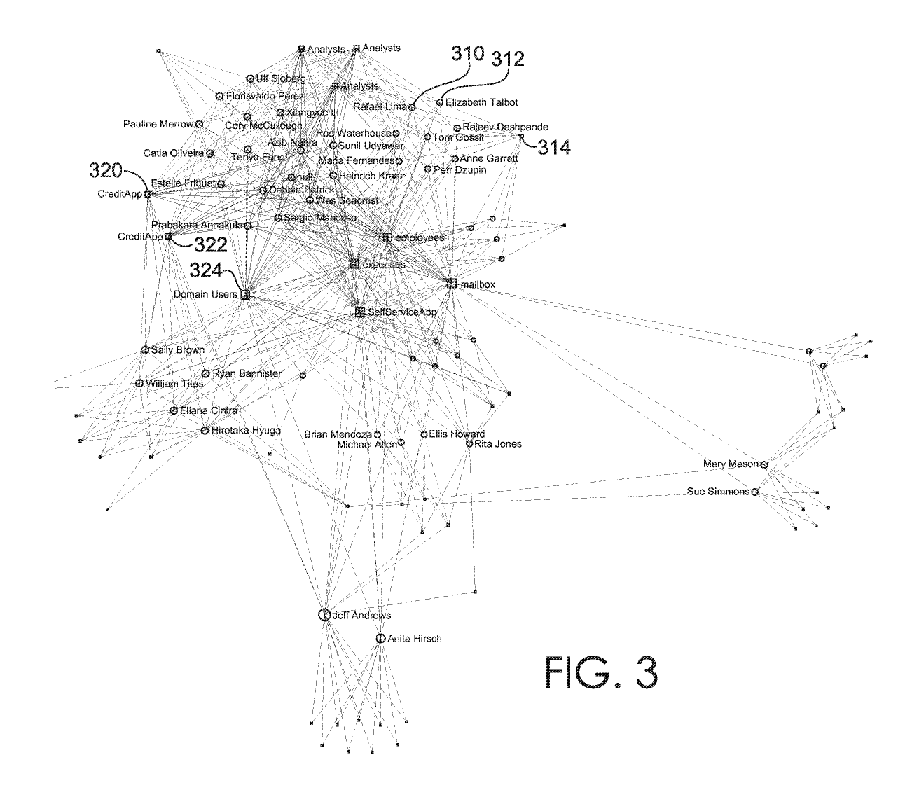

FIGS. 3-9 are exemplary diagrams illustrating visualizations of security entitlement relationships to identify security patterns and mitigate risks, in accordance with embodiments of the present disclosure. By way of example to illustrate, FIG. 3 illustrates an exemplary visualization that may be provided utilizing the visualization system 100 of FIG. 1. As shown in FIG. 3, a node-edge graph shows the relationships between identities 310, 312, 314 and entitlements 320, 322, 324. Each edge between nodes represents a relationship between the nodes (an identity having access to an entitlement).

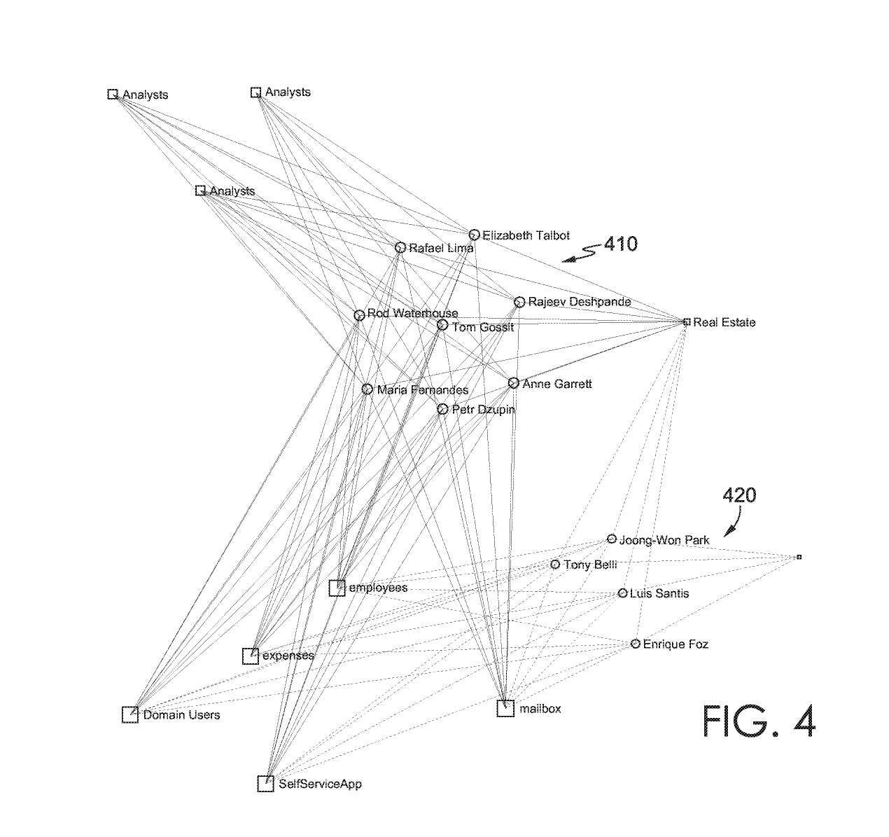

Referring next to FIG. 4, the visualization may, in some embodiments, enable role discovery. In other words, the visualization may enable the user to readily identify two specific types of entitlement access that might correspond to a role 410, 420. The user may interact with the visualization to filter the data provided by the visualization by department and provide color coding linkages by title. In this way, a user might provide a new employee specific entitlements based on the selected department and title corresponding to a selected role 410, 420. A rule can be created when the user selects the desired role 410, 420 that links the user to the entitlements corresponding to the role 410, 420. A new employee that matches the attributes associated with the role will be provided the same access to role 410 or role 420.

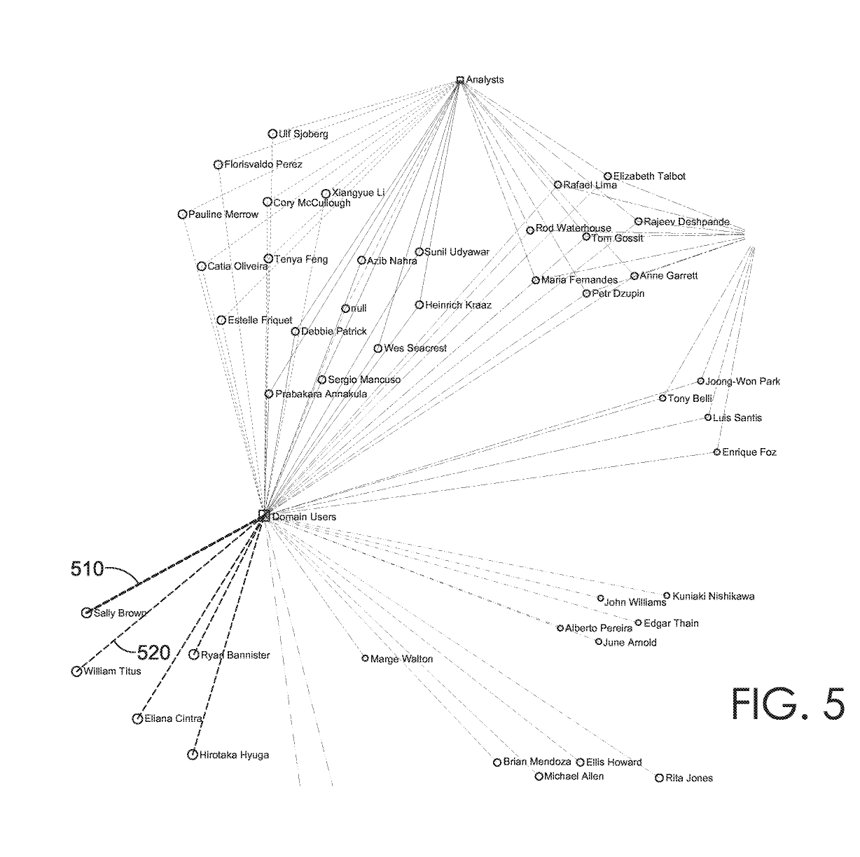

In some embodiments, as shown in FIG. 5, the visualization provides risk identification. As illustrated, red linkage 510, 520 may identify access in violation of business policies. The level of risk may be indicated by thickness of line or some other visual indication (e.g., the thicker the line, the higher the level of risk). In this example, Sally Brown has a higher level of risk than William Titus.

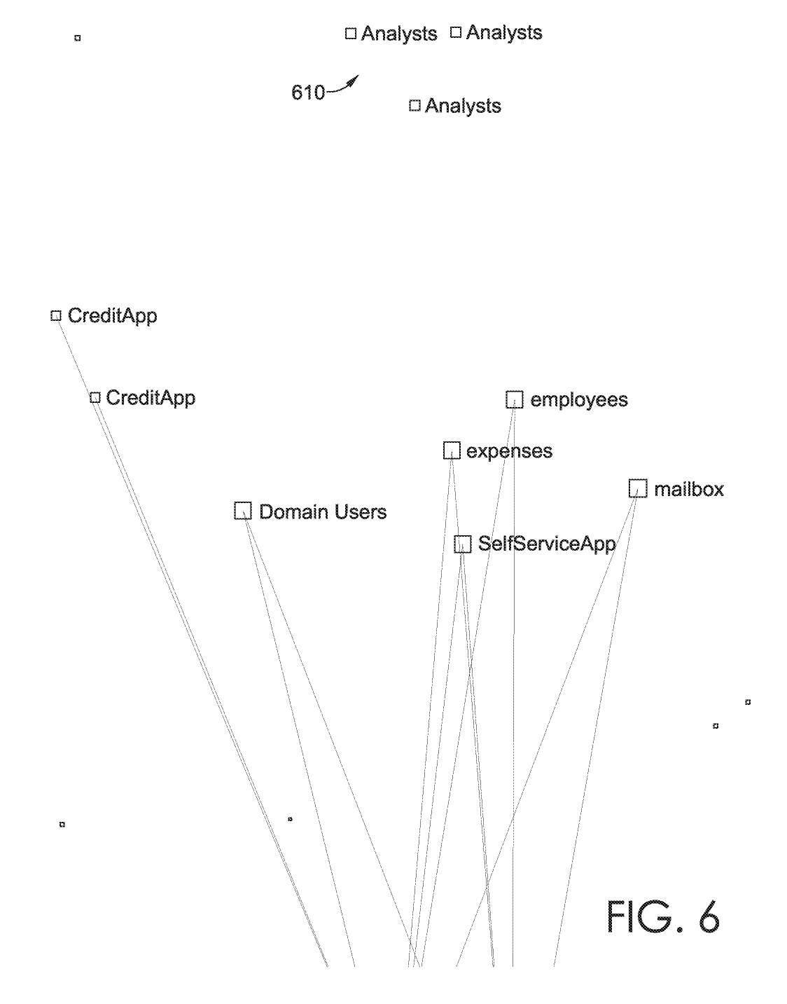

Referring next to FIG. 6, in some embodiments, the visualization may indicate that some entitlements 610 have no access. For example, three groups (e.g., analysts, Analysts, and analysts) 610 do not have any links to any identities or entitlements. As part of routine risk mitigation, the user may determine these entitlements should be removed as part of clean up since they are providing no active access yet may still provide access to sensitive data. Because the user may determine these unused groups represent a security risk, the user may interact with the visualization (such as by drawing a circle around the entitlements). This interaction causes a rule to be created that is communicated to an organization device (e.g., automated provisioning device) and the groups can be removed by the organization device or the appropriate system, application, resource, etc.

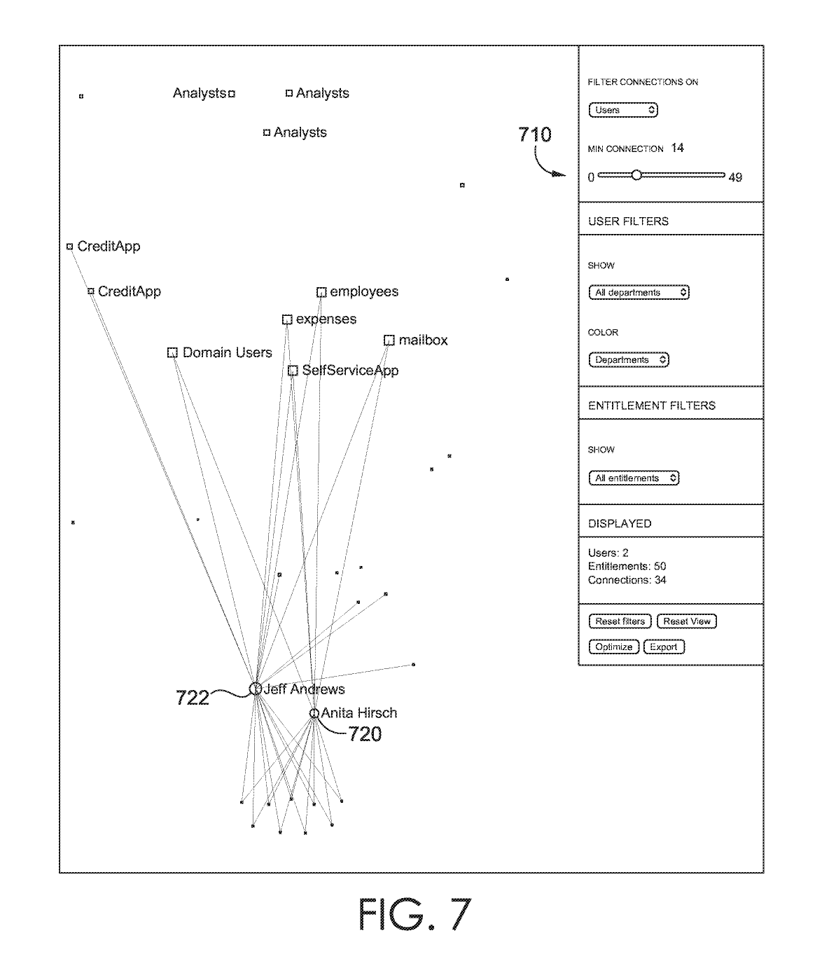

In some embodiments, as shown in FIG. 7, a filter 710 can be applied so the visualization only shows identities 720, 722 having a high quantity of linkages to entitlements. This enables a user to readily identify collectors, or identities that have a high number of entitlements as compared to other identifies in the organization. For example, a particular employee (represented by the identity) may have been granted, or collected, access by moving through various jobs within the organization. However, the high number of entitlements that identity has collected also represents potential risk. In many instances, entitlements that should have been removed when the employee changed jobs within the organization were not and the organization may be vulnerable to unnecessary risk. The visualization helps the user identify these entitlements and the user can interact with the visualization to create a rule that removes them for the identity and mitigates the risk.

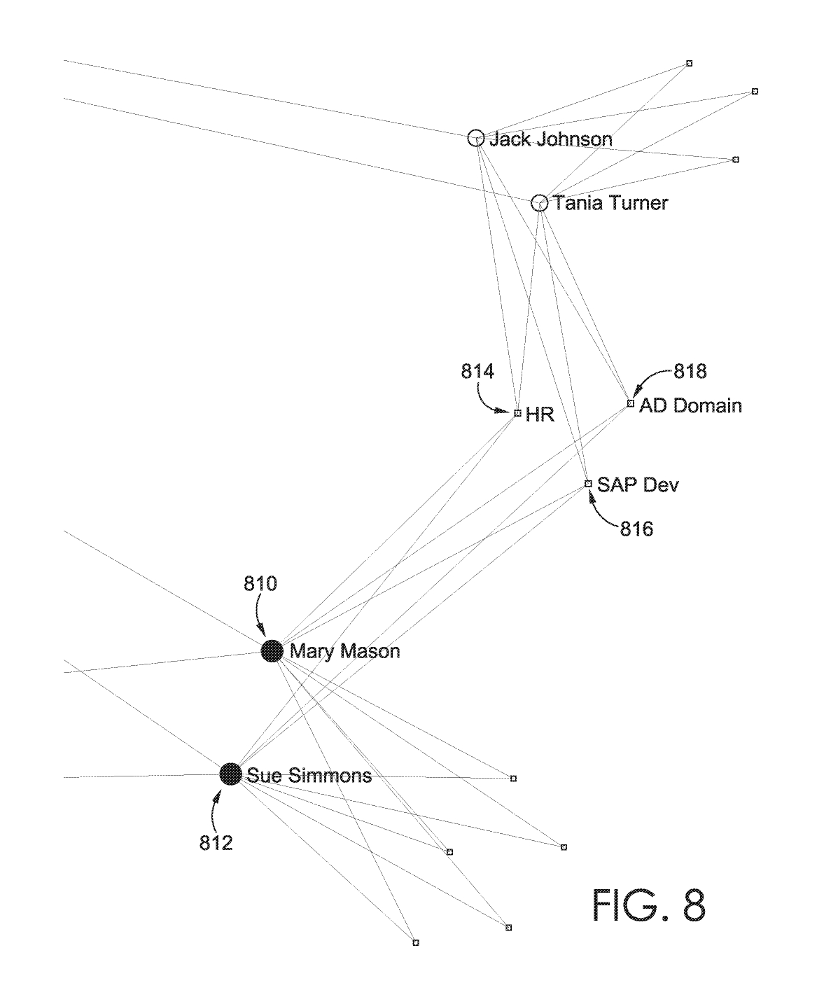

Referring next to FIG. 8, in some embodiments, the visualization can be filtered to show terminated users 810, 812 that still have access to entitlements 814, 816, 818. As shown, the visualization may be color-coded to show terminated users 810, 812 (e.g., red nodes). The entitlements 814, 816, 818 may also be color-coded (e.g., red nodes) to show entitlements that are connected to terminated users 810, 812. This enables the user to readily identify any active access to entitlements the terminated users 810, 812 may still have and what entitlements 814, 816, 818 are affected.

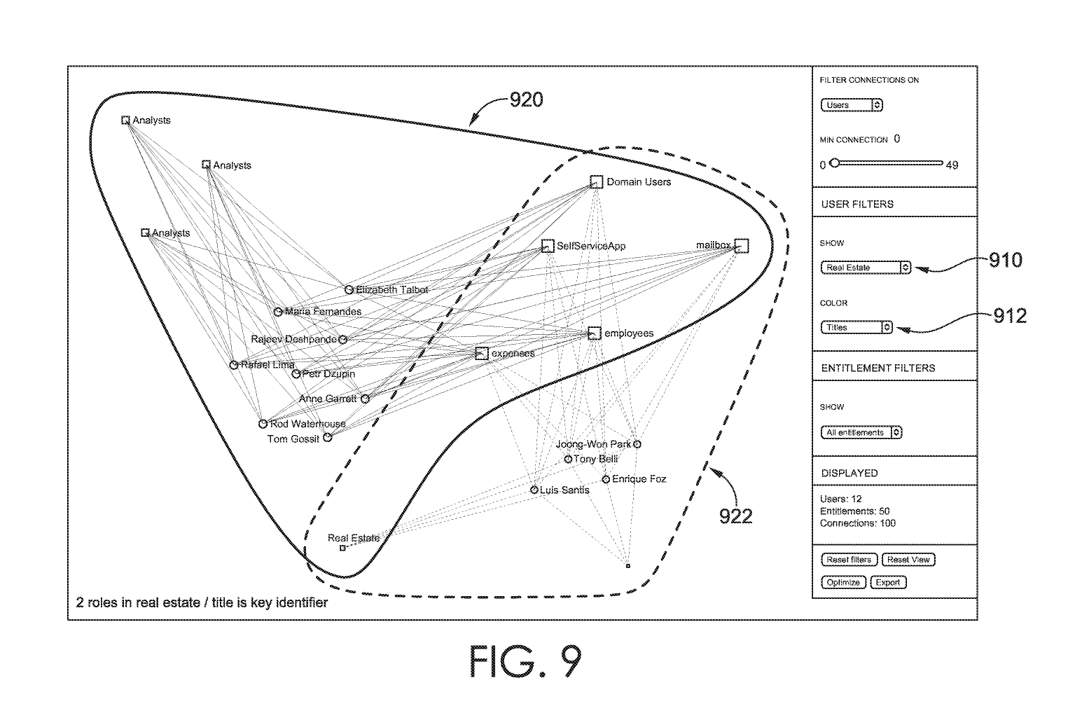

In some embodiments, as shown in FIG. 9, the visualization may initially be filtered to show a particular business unit within the organization, as well as titles associated with that business unit. In this example, the visualization is filtered to show the real estate business unit and the titles or roles of employees (which may be color-coded) in the real estate business unit. Based on the color coding, the user may readily identify the roles within the real estate business unit by identifying patterns of access to entitlements. In other words, identities that have similar entitlements likely share a role within the business unit. For example, as illustrated, there are two clear roles. Further, the user may a draw a line 920, 922 around the identities and associated entitlements to create a rule. The rule can then be utilized, such as by the organization device 116 of FIG. 1, to grant the same access to entitlements when a new employee having the same title or role joins the organization. A line can also be drawn around a node (e.g., user or entitlement) or edge (relationship between the user and entitlement) to create a rule that is communicated to the organization device to remove access for a particular user or entitlement. In this way, the rule can be utilized to create a new object/artifact or remove access to another system.

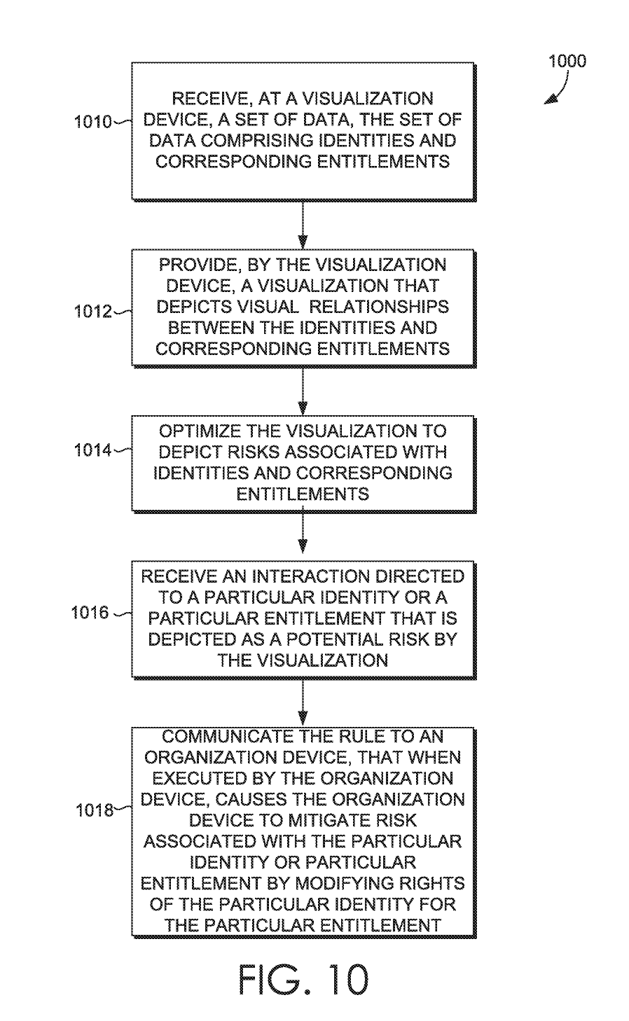

Turning now to FIG. 10, a flow diagram is provided that illustrates a method 1000 for providing visualizations of security entitlement relationships to identify security patterns and mitigate risks, in accordance with an embodiment of the present disclosure. For instance, the method 1000 may be employed utilizing the visualization system 100 of FIG. 1. As shown at step 1010, a set of data is received, at a visualization device, from an organization device. The set of data comprises identities and corresponding entitlements. In some embodiments, the set of data is received by the visualization device in real time from the organization device.

In response, the visualization device provides, at step 1012, a visualization that depicts visual relationships between the identities and corresponding entitlements. In one embodiment, the visualization is a node-edge graph. Based on a user interaction, the visualization is optimized, at step 1014, to depict potential risks associated with selected identities and corresponding entitlements. The potential risks may comprise, in various embodiments, a portion of the identities having a high quantity of corresponding entitlements compared to other identities in the organization, terminated identities having a corresponding entitlement, or null identities that are unknown to the organization device having a corresponding entitlement. The optimizing may cause the visualization to change in accordance with the selection.

At step 1016, an interaction directed to a particular identity or a particular entitlement that is depicted as a potential risk by the visualization is received. The interaction causes the visualization device to create a rule for the particular identity or the particular entitlement. In some embodiments, the interaction with the visualization causes the action to be performed in real time at the organization device.

The rule is communicated to the organization device, at step 1018, that when executed by the organization device, causes the organization device to mitigate risk associated with the particular identity or particular entitlement by modifying rights of the particular identity for the particular entitlement. The rights may be modified at the organization device or any device, system, application, or database for which the organization device has access and the ability to modify rights.

In some embodiments, the interaction includes removing a link between the particular identity and the particular entitlement. The corresponding rule created by the visualization device causes the organization device to remove access to the particular entitlement for a user corresponding to the particular identity.

In some embodiments, a non-risk interaction is received that includes adding a link between the particular identity and the particular entitlement. The corresponding rule created by the visualization device causes the organization device to provide access to the particular entitlement for a user corresponding to the particular identity.

In some embodiments, a non-risk interaction is received that includes selecting the particular identity and the particular entitlement. The corresponding rule created by the visualization device causes the organization device to provide similar access to another identity based on the access the particular identity has to the particular entitlement. In some embodiments, the rule causes the organization device to generate an audit report to indicate why the particular identity has access to the particular entitlement.

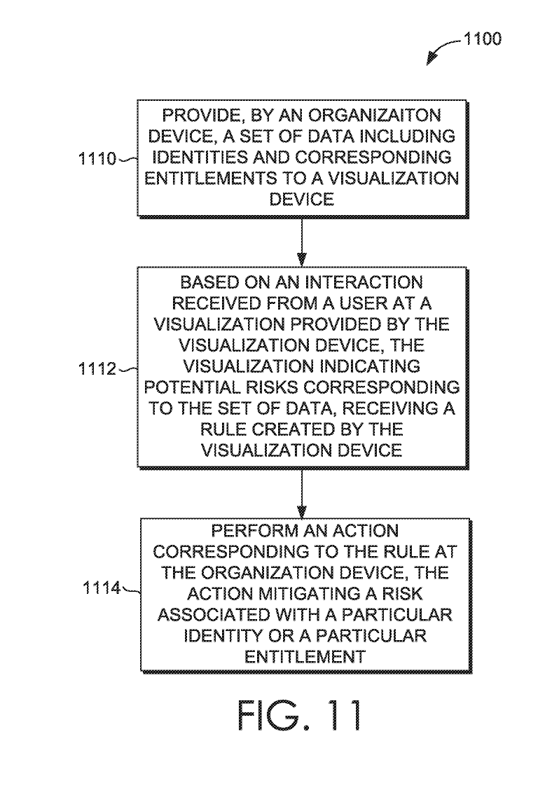

In some embodiments, and referring now to FIG. 11, a flow diagram is provided that illustrates a method 1100 for providing visualizations of security entitlement relationships to identify security patterns and mitigate risks, in accordance with an embodiment of the present disclosure. For instance, the method 1100 may be employed utilizing the visualization system 100 of FIG. 1. As shown at step 1110, a set of data comprising identities and corresponding entitlements is provided by an organization device to a visualization device.

The visualization device utilizes at least a portion of the set of data to generate a visualization. In one embodiment, the visualization is a node-edge graph where the nodes represent identities or entitlements and the edges represent relationships between the identities and entitlements. The visualization indicates potential risks corresponding to the set of data. In various embodiments, the potential risks are identities having a high quantity of corresponding entitlements compared to other identities in the organization, terminated identities having a corresponding entitlement, or null identities that are unknown to the organization device having a corresponding entitlement.

Based on an interaction received from a user at a visualization provided by the visualization device, a rule created by the visualization device is received, at step 1112, by the organization device. An action corresponding to the rule is performed, at step 1114, by the organization device. The action mitigates a risk associated with a particular identity or a particular entitlement.

In some embodiments, the interaction includes removing a link between a particular identity and a particular entitlement. The corresponding action causes the organization device to remove access to the particular entitlement for a user corresponding to the particular identity.

In some embodiments, the interaction includes adding a link between a particular identity and a particular entitlement. The corresponding action causes the organization device to provide access to the particular entitlement for a user corresponding to the particular identity.

In some embodiments, the interaction includes selecting a particular identity and corresponding entitlements. The corresponding action causes the organization device to provide similar access to another identity based on the access the particular identity has to the particular entitlement.

Having described embodiments of the present disclosure, an exemplary operating environment in which embodiments of the present disclosure may be implemented is described below in order to provide a general context for various aspects of the present disclosure. Referring to FIG. 12 in particular, an exemplary operating environment for implementing embodiments of the present disclosure is shown and designated generally as computing device 1200. Computing device 1200 is but one example of a suitable computing environment and is not intended to suggest any limitation as to the scope of use or functionality of the inventive embodiments. Neither should the computing device 1200 be interpreted as having any dependency or requirement relating to any one or combination of components illustrated.

The inventive embodiments may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The inventive embodiments may be practiced in a variety of system configurations, including handheld devices, consumer electronics, general-purpose computers, more specialty computing devices, etc. The inventive embodiments may also be practiced in distributed computing environments where tasks are performed by remote-processing devices that are linked through a communications network.

With reference to FIG. 12, computing device 1200 includes a bus 1210 that directly or indirectly couples the following devices: memory 1212, one or more processors 1214, one or more presentation components 1216, input/output (I/O) ports 1218, input/output (I/O) components 1220, and an illustrative power supply 1222. Bus 1210 represents what may be one or more busses (such as an address bus, data bus, or combination thereof). Although the various blocks of FIG. 12 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors recognize that such is the nature of the art, and reiterate that the diagram of FIG. 12 is merely illustrative of an exemplary computing device that can be used in connection with one or more embodiments of the present disclosure. Distinction is not made between such categories as “workstation,” “server,” “laptop,” “handheld device,” etc., as all are contemplated within the scope of FIG. 12 and reference to “computing device.”

Computing device 1200 typically includes a variety of computer-readable media. Computer-readable media can be any available media that can be accessed by computing device 1200 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 1200. Computer storage media does not comprise signals per se. Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer-readable media.

Memory 1212 includes computer-storage media in the form of volatile and/or nonvolatile memory. The memory may be removable, non-removable, or a combination thereof. Exemplary hardware devices include solid-state memory, hard drives, optical-disc drives, etc. Computing device 1200 includes one or more processors that read data from various entities such as memory 1212 or I/O components 1220. Presentation component(s) 1216 present data indications to a user or other device. Exemplary presentation components include a display device, speaker, printing component, vibrating component, etc.

I/O ports 1218 allow computing device 1200 to be logically coupled to other devices including I/O components 1220, some of which may be built in. Illustrative components include a microphone, joystick, game pad, satellite dish, scanner, printer, wireless device, etc. The I/O components 1220 may provide a natural user interface (NUI) that processes air gestures, voice, or other physiological inputs generated by a user. In some instances, inputs may be transmitted to an appropriate network element for further processing. An NUI may implement any combination of speech recognition, touch and stylus recognition, facial recognition, biometric recognition, gesture recognition both on screen and adjacent to the screen, air gestures, head and eye tracking, and touch recognition associated with displays on the computing device 1200. The computing device 1200 may be equipped with depth cameras, such as stereoscopic camera systems, infrared camera systems, RGB camera systems, and combinations of these, for gesture detection and recognition. Additionally, the computing device 1200 may be equipped with accelerometers or gyroscopes that enable detection of motion. The output of the accelerometers or gyroscopes may be provided to the display of the computing device 1200 to render immersive augmented reality or virtual reality.

As can be understood, embodiments of the present disclosure provide for an objective approach for providing visualizations of security entitlement relationships to identify security patterns and mitigate risks. The present disclosure has been described in relation to particular embodiments, which are intended in all respects to be illustrative rather than restrictive. Alternative embodiments will become apparent to those of ordinary skill in the art to which the present disclosure pertains without departing from its scope.

From the foregoing, it will be seen that this disclosure is one well adapted to attain all the ends and objects set forth above, together with other advantages which are obvious and inherent to the system and method. It will be understood that certain features and subcombinations are of utility and may be employed without reference to other features and subcombinations. This is contemplated by and is within the scope of the claims.

What is claimed is:

1. A method comprising:
receiving, at a visualization device, a set of data from an organization device, the set of data comprising identities and corresponding entitlements;
providing, by the visualization device, a visualization that depicts visual relationships between the identities and corresponding entitlements, the visualization being a node-edge graph;
optimizing the visualization to depict potential risks associated with selected identities and corresponding entitlements, the potential risks comprising a portion of the identities having a high quantity of corresponding entitlements compared to other identities in the organization, terminated identities having a corresponding entitlement, or null identities that are unknown to the organization device and having a corresponding entitlement;
receiving an interaction directed to a particular identity or a particular entitlement that is depicted as a potential risk by the visualization, the interaction causing the visualization device to create a rule for the particular identity or the particular entitlement; and
communicating the rule to the organization device that, when executed by the organization device, causes the organization device to mitigate risk associated with the particular identity or particular entitlement by modifying rights of the particular identity for the particular entitlement.

2. The method of claim 1, wherein the interaction includes removing a link between the particular identity and the particular entitlement.

3. The method of claim 2, further comprising communicating the rule to the organization device that, when executed by the organization device, causes the organization device to remove access to the particular entitlement for a user corresponding to the particular identity.

4. The method of claim 1, further comprising receiving a non-risk interaction that includes adding a link between the particular identity and the particular entitlement, the interaction causing the visualization device to create a rule for the particular identity and the particular entitlement.

5. The method of claim 4, further comprising communicating the rule to the organization device that, when executed by the organization device, causes the organization device to provide access to the particular entitlement for a user corresponding to the particular identity.

6. The method of claim 1, further comprising receiving a non-risk interaction that includes selecting the particular identity and the particular entitlement, the interaction causing the visualization device to create a rule for the particular identity and the particular entitlement.

7. The method of claim 6, further comprising communicating the rule to the organization device that, when executed by the organization device, causes the organization device to provide similar access to another identity based on the access the particular identity has to the particular entitlement.

8. The method of claim 1, wherein the rule, when executed by the organization device, causes the organization device to generate an audit report to indicate why the particular identity has access to the particular entitlement.

9. The method of claim 1, wherein the optimizing corresponds to a selection made by a user, the optimizing causing the visualization to change in accordance with the selection.

10. The method of claim 1, wherein the set of data is received by the visualization device in real time from the organization device.

11. The method of claim 1, wherein the interaction with the visualization causes the action to be performed in real time at the organization device.

12. A method comprising:
providing, by an organization device, a set of data comprising identities and corresponding entitlements to a visualization device;
based on an interaction received from a user at a visualization provided by the visualization device, the visualization indicating potential risks corresponding to the set of data, receiving a rule created by the visualization device; and
performing an action corresponding to the rule by the organization device, the action mitigating a risk associated with a particular identity or a particular entitlement.

13. The method of claim 12, wherein the interaction includes removing a link between a particular identity and a particular entitlement and the action causes the organization device to remove access to the particular entitlement for a user corresponding to the particular identity.

14. The method of claim 12, wherein the interaction includes adding a link between a particular identity and a particular entitlement and the action causes the organization device to provide access to the particular entitlement for a user corresponding to the particular identity.

15. The method of claim 12, wherein the interaction includes selecting a particular identity and corresponding entitlements and the action causes the organization device to provide similar access to another identity based on the access the particular identity has to the particular entitlement.

16. The method of claim 12, wherein the visualization is a node-edge graph.

17. The method of claim 12, wherein the potential risks are identities having a high quantity of corresponding entitlements compared to other identities in the organization.

18. The method of claim 12, wherein the potential risks are terminated identities having a corresponding entitlement.

19. The method of claim 12, wherein the potential risks are null identities that are unknown to the organization device and having a corresponding entitlement.

20. A computerized system for facilitating automated correlation and deduplication of identities, the system comprising:
a processor; and
a non-transitory computer storage medium storing computer-useable instructions that, when used by the processor, cause the processor to:
receive, at a visualization device, a set of data from an organization device, the set of data comprising identities and corresponding entitlements;
provide, by the visualization device, a visualization that depicts visual relationships between the identities and corresponding entitlements, the visualization being a node-edge graph;
optimize the visualization to depict potential risks associated with selected identities and corresponding entitlements;
receive an interaction directed to a particular identity or a particular entitlement that is depicted as a potential risk by the visualization, the interaction causing the visualization device to create a rule for the particular identity or the particular entitlement; and
communicate the rule to the organization device that, when executed by the organization device, causes the organization device to perform an action that mitigates risk associated with the particular identity or the particular entitlement.
